(19) United States
(12) Patent Application Publication
(10) Pub. No.: US 2005/0000809 A1
(43) Pub. Date: Jan. 6, 2005

(54) Integrated flow passage

(75) Inventors: Gilles Plichon, Williamsburg, VA (US); Daniel Stahlmann, Williamsburg, VA (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 10/876,053

(22) Filed: Jun. 24, 2004

Related U.S. Application Data
(60) Provisional application No. 60/484,852, filed on Jul. 3, 2003.

(51) Int. Cl. G01N 27/26

(52) U.S. Cl. 204/422; 204/424

(57) ABSTRACT

A fuel sensor assembly includes a housing and back plate forming a cathode, and a chamber containing an anode. Fuel flows into the chamber surrounds the anode and is continuously replenished providing accurate and current measurements of fuel characteristics indicative of fuel content. A first opening and a second opening are offset a distance creating a flow path through the chamber that constantly circulates and replenishes fuel adjacent the sensor. The offset first and second openings create improved fuel content measurements by improving circulation of fuel through the chamber and around the anode.

This application claims priority to U.S. Provisional Application No. 60/484,852, which was filed on Jul. 3, 2003.

### BACKGROUND OF THE INVENTION

This invention relates generally to a sensor for measuring characteristics of a flowing fuel and specifically to a sensor housing that provides for complete filling and continuous replenishment of a sensor cavity.

Mixing fuels with additives such as methanol or ethanol is known to provide increased combustion efficiency with decreased pollutants. The ratio of additives varies from station to station, and therefore from tank to tank. The different ratios of additives within the fuel cause variations in engine performance. Such variations in engine performance create the need to adjust engine-operating parameters based on the current ratio of additives within the fuel.

Typically, a sensor is provided that monitors fuel characteristics indicative of the type and ratios of additives contained within the fuel. One such known sensor utilizes a tube and sleeve to form an anode and a cathode of a capacitor. The sensor measures a dielectric constant or resistivity of fuel flowing between the anode and the cathode that are indicative of the content and ratio of the fuel. Operation of the engine may than be adjusted to accommodate the fuel ratio. Typically, such sensors are disposed within a fuel line to continuously monitor characteristics of the fuel.

Accurate and consistent fuel characteristic measurements require complete filling of the space between and around the sensor. Incomplete filling of fuel can cause inaccuracies in sensor measurements. It is known to utilize flow through sensors that mount within a fuel line that provide acceptable filling of fuel around the sensor. However, in some applications an inline, flow through sensor configuration is not desirable or possible.

Fuel sensor housing assemblies that include the inlet and outlet on a common side provide for non-inline applications. Because the inlet and outlet are disposed on a common side fuel enters a chamber with the sensor transverse to fuel flow through the inlet and outlet. An opening is provided from the inlet to the chamber and from the chamber to the outlet. Typically, these openings are orientated directly across from each other, for example along a bottom surface of the chamber. This relative orientation between the openings creates a flow path directly across the chamber such that while fuel flows through the chamber along the bottom surface, a quantity of fuel accumulates and re-circulates in an upper portion of the chamber. Recirculating fuel prevents the replenishment of fuel adjacent the sensor that in turn affects the accuracy of sensor measurements. Further, recirculating fuel can generate pockets of fuel vapor that further distort sensor measurements.

Accordingly, it is desirable to develop a non-inline fuel sensor housing assembly that continuously replenishes fuel adjacent the sensor to improve accuracy and substantially eliminate recirculation of fuel and accumulation of fuel vapors adjacent the sensor.

### SUMMARY OF THE INVENTION

This invention is a fuel sensor assembly including an inlet and an outlet on a common side of a housing. The inlet and outlet communicate with a chamber containing an anode. First and second openings to the chamber are offset to provide continuous replenishment of fuel adjacent the anode.

The fuel sensor assembly includes the housing and a back plate that define the chamber. The anode is disposed within the chamber and is surrounded by a continuously replenished flow of fuel. The housing is formed from an electrically conductive material and forms a cathode. The anode and cathode form a capacitor device that gathers information on dielectric and resistivity properties of the fuel that are indicative of a specific ratio or concentration of additives within the fuel.

The first opening communicates fuel from the inlet to the chamber and the second opening communicates fuel from the chamber to the outlet. The first opening and second opening are not directly across the chamber from each other. Instead, the first and second openings are offset a longitudinal distance from each other. The offset orientation of the first opening relative to the second opening prevents fuel from becoming trapped and re-circulating within the chamber.

Accordingly, the fuel sensor assembly of this invention provides a non-inline fuel sensor that continuously replenishes fuel adjacent the sensor to improve accuracy and substantially eliminate recirculation of fuel and accumulation of fuel vapors adjacent the sensor.

These and other features of the present invention can be best understood from the following specification and drawings, the following of which is a brief description.

### BRIEF DESCRIPTION OF THE DRAWINGS

FIG. 1 is a cross-sectional view of a fuel sensor assembly.

FIG. 2 is a cross-sectional view of a housing for the fuel sensor assembly.

FIG. 3 is a sectional view of the housing of FIG. 2.

FIG. 4 is a cross-sectional view of another housing for the fuel sensor assembly.

FIG. 5 is a sectional view of the housing shown in FIG. 4.

### DETAILED DESCRIPTION OF THE PREFERRED EMBODIMENT

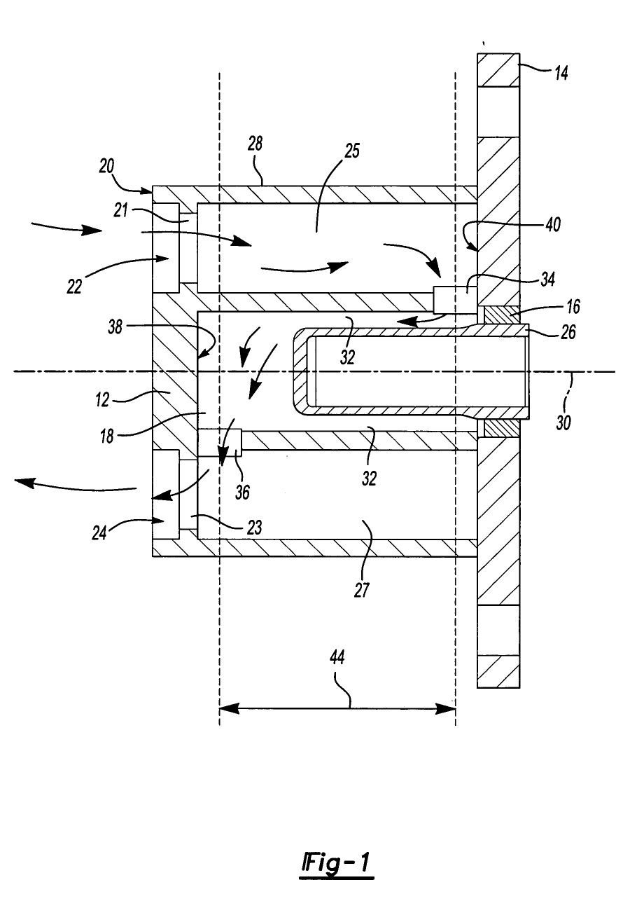

Referring to FIG. 1, a fuel sensor assembly 10 includes a housing 12 that comprises a cathode 28, a back plate 14, and a chamber 18 containing an anode 26. Fuel flows into the chamber 18 surrounds the anode 26 and is continuously replenished providing accurate and current measurements of fuel characteristics indicative of fuel content. The chamber 18 also evacuates fuel vapors, further preventing formation of disturbances that can disrupt measurements.

The housing 12 includes a first side 20 having an inlet 22 and an outlet 24. Having both the inlet 22 and the outlet 24 on the same side provides for applications were a straight flow through or inline sensor is not a desirable alternative. The inlet 22 includes an inlet opening 21 and an inlet chamber 25. The outlet 24 includes an outlet opening 23 and an outlet chamber 27. The inlet opening 21 and the outlet opening 23 are sized to provide a desired flow rate and pressure drop between the inlet 22 and outlet 24.

The fuel sensor assembly 10 measures characteristics of fuel flowing around the anode 26 that are indicative of a ratio of additives such as methanol and ethanol mixed within the fuel. The fuel sensor assembly 10 preferably gathers information on dielectric and resistivity properties of the fuel that are indicative of a specific ratio or concentration of an additive within the fuel. Modifications can then be made to engine operation to optimize performance responsive to the ratio and type of additive within the fuel.

The fuel sensor assembly 10 is preferably a capacitance device that includes the anode 26 surrounded by the cathode 28. The cathode 28 comprises the entire housing 12 and the back plate 14. The anode 26 is concentric about a longitudinal axis 30 centered within the chamber 18. The anode 26 is electrically insulated from the cathode 28 and the back plate 14 by an insulator 16. Preferably, the insulator is a glass seal disposed between the anode 26 and the back plate 14.

Fuel flows through an annular passage 32 between the anode 26 and the cathode 28. Fuel continually flows through the annular passage 32 and is replenished such that the measurements taken are indicative of current fuel characteristics.

The fuel sensor assembly 10 takes dielectric measurements that reflect the current composition of the fuel. Although a capacitance type fuel sensor having an anode and a cathode is shown and described, it should be understood that other fuel sensing devices and capacitor configurations as are know to a worker skilled in the art are within the contemplation of this invention.

The performance and consistency of measurements gathered by the fuel sensor assembly 10 are dependent on the complete filling of the chamber 18 and surrounding of the anode 26 with liquid fuel. Fuel vapors traveling with the liquid fuel can detract from the performance of the fuel sensor assembly 10. Further, fuel within the chamber 18 is refreshed continually such that the reading of the fuel sensor assembly 10 accurately reflects fuel flowing to the vehicle engine. Fuel trapped and recirculated within the chamber 18 may distort readings from the fuel sensor assembly 10.

The housing 12 includes a first opening 34 from the inlet 22 to the chamber 18 and a second opening 36 communicating fuel from the chamber 18 to the outlet 24. The chamber 18 includes a top surface 38 and a bottom surface 40. The first opening 34 is disposed adjacent the bottom surface 40 and the second opening 36 is disposed adjacent the top surface 38. The first opening 34 and second opening 36 are not spaced directly across the chamber 18 from each other. Instead, the first opening 34 is offset relative to the second opening 36, preventing fuel from becoming trapped and re-circulating within the chamber 18.

The first opening 34 is disposed along a first axis 29 that is transverse to the longitudinal axis 30, and the second opening 36 is disposed along a second axis 31, also transverse to the longitudinal axis 30. The first and second axes 29,31 are spaced a distance 44 apart from each other. The offset distance 44 between the first and second openings 34, 36 prevent fuel from flowing directly through the chamber 18. Instead, incoming fuel must mix and flow throughout the entire chamber 18. Flow between the offset first and second openings 34, 36 prevents fuel from accumulating and recirculating within the chamber 18.

Incoming fuel from the inlet 22 passes through the first opening 34 and into the chamber 18. Fuel flows upwardly toward the top surface 38 of the chamber 18 toward the second opening 36. The offset distance 44 between the first and second openings 34, 36 creates a flow path through the chamber 18 that constantly circulates and replenishes fuel adjacent the anode 26. Fuel flowing into the chamber 18 is forced to circulate from the bottom surface 40 to the top surface 38, thereby preventing accumulation and recirculation of fuel. The flow path created by the relative orientation of the first and second openings 34, 36 provides the desired change over of fuel required for accurate and current measurements indicative of fuel content. Further, the continuous replenishment of fuel evacuates fuel vapors from the chamber 18, thereby further improving sensor performance.

The housing 12 is formed from a single part that is attached to the back plate 14 to define the chamber 18. The back plate 14 forms the bottom surface 40 of chamber 18. The housing 12 is mounted to the back plate 14. Preferably, the housing 12 is formed from an injection molding process with electrically conductive materials. The housing 12 is configured such that additional process steps are not required to form the inlet 22, outlet 24 or the first and second openings 34, 36.

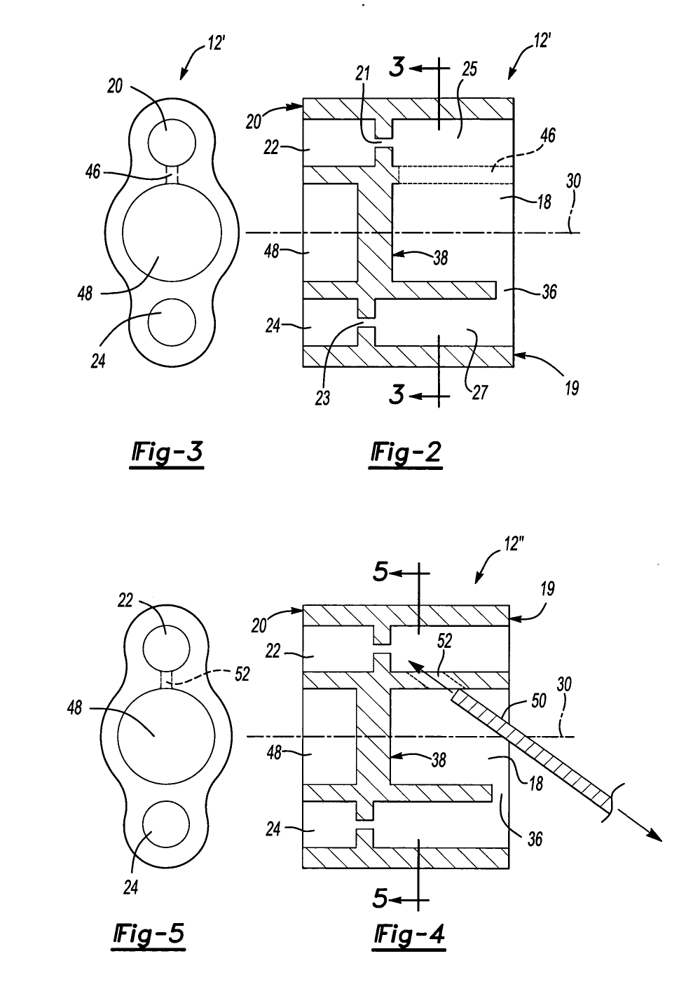

Referring to FIG. 2, a cross-section of a housing 12′ according to this invention is shown. The housing 12′ includes the inlet 22 and outlet 24 disposed on a front side 20. The inlet 22 includes the inlet passage 21 through to the inlet chamber 25. A cavity 48 is cored out between the inlet 22 and the outlet 24 that provides for a uniform wall thickness throughout the entire housing 12′. A slot 46 is formed along the longitudinal length of the inlet chamber 25. The slot 46 communicates fuel from the inlet chamber 25 to the chamber 18. Fuel enters the chamber 18 along the entire length of the slot 46 providing the desired recirculation of fuel. The second opening 36 is disposed adjacent a bottom side 19 of the housing 12′. The housing 12′ is provided with the slot 46 and the second opening 36 positioned as such to allow one-piece injection molding without the need for additional machining steps.

Molding passages transverse to the longitudinal axis 30 require secondary machining operations, or complex core and slide systems. The slot 46 and second opening 36 can be formed by a simply mold configuration movable along the longitudinal axis 30. Accordingly, the slot 46 combined with the second opening 36 provides the desired flow path without secondary machining. As appreciated, a slot could be used for the opening between the chamber 18 and the outlet 24 in combination with an opening between the inlet 22 and the chamber 18.

Referring to FIG. 3, a top view of the housing 12′ is shown. The housing 12′ preferably includes circular openings that form the inlet 22, outlet 24 and chamber 18. The use of circular opening facilitates the connection of the housing 12′ to fuel lines and substantially reduces any additional machining requirements for attaching to a vehicle fuel line. Further, the circular shape of the chamber 18 eliminates corners that can generate undesirable pockets of trapped fuel or fuel vapors. As appreciated, the specific size and shape of the inlet 22, outlet 24 and chamber 18 can be modified within the scope and contemplation of this invention according to application specific requirements.

Referring to FIGS. 4 and 5 another housing 12″ according to this invention is shown and includes an opening 52 communicating from the inlet chamber 25 to the chamber 18. The opening 52 is formed during an injection molding process by a slide 50 moving into the housing 12″ at an angle relative to the longitudinal axis 30. The slide 50 forms the opening 52 at angle adjacent the top surface 38 of the chamber 18. The use of the slide 50 provides the desired longitudinally offset openings into the chamber 18 that provide the desired fuel flow for surrounding and continually replenishing fuel adjacent the anode 26.

The angular form of the opening 52 provides for the use of the slide 50 without complex mechanisms usually required to form transversely orientated openings. Further the angular form of the opening 52 provides for placement in a desired location that provides the desired flow of fuel through the chamber 18 and adjacent the anode 26.

The specific molding process utilized for forming the housing 12″ can be of any type known to a worker skilled in the art including, for example, plastic injection molding, and metal injection molding. The features of the housing 12″ are such that common injection molding techniques as are known to a worker skilled in the art can be employed, thereby reducing fabrication costs.

The fuel sensor assembly 10 of this invention provides the desired full filling adjacent the anode 26 that improves accuracy and substantially eliminates formation and accumulation of fuel vapors within the chamber 18. Further, the housing 12 includes features that provide for the fabrication of transverse openings with known plastic and metal injection molding techniques.

Although a preferred embodiment of this invention has been disclosed, a worker of ordinary skill in this art would recognize that certain modifications would come within the scope of this invention. For that reason, the following claims should be studied to determine the true scope and content of this invention.

1. A fuel sensor housing assembly comprising:
an inlet and an outlet disposed on a common side;
a fluid chamber for a sensor;
a first opening between said inlet and said fluid chamber; and
a second opening between said fluid chamber and said outlet, wherein said first opening and said second opening are transverse to said fluid chamber and said first opening and said second opening are spaced a longitudinal distance apart

2. The assembly as recited in claim 1, where said fluid chamber includes a top surface and a bottom surface and one of said first opening and said second opening is disposed adjacent said top surface and the other of said first opening and said second opening is disposed adjacent said bottom surface.

3. The assembly as recited in claim 2, including a back plate defining said bottom-surface of said fluid chamber.

4. The assembly as recited in claim 1, wherein said fluid chamber is disposed along a longitudinal axis, said first opening disposed along a first axis transverse to said longitudinal axis, and said second opening disposed along a second axis transverse to said longitudinal axis and spaced apart from said first axis.

5. The assembly as recited in claim 4, wherein said first opening is disposed at an angle relative to said first axis.

6. The assembly as recited in claim 4, wherein said inlet and said outlet are both substantially parallel to said longitudinal axis.

7. The assembly as recited in claim 1, wherein said first opening comprises a slot.

8. The assembly as recited in claim 1, wherein said inlet, said outlet, and said fluid chamber are substantially circular.

9. The assembly as recited in claim 1, wherein said housing comprises a metal injection molded part.

10. A fuel sensor assembly comprising:
a housing including a first side, an inlet and an outlet, said inlet and outlet both disposed on said first side;
a fluid chamber defined within said housing and in fluid communication with said inlet and said outlet;
a first opening between said inlet and said fluid chamber;
a second opening between said fluid chamber and said outlet, said second opening is offset from said first opening; and
a sensor for measuring a characteristic of fuel within said chamber indicative of fuel content.

11. The assembly as recited in claim 10, wherein said sensor comprises a cathode comprising said housing and an anode disposed within said fluid chamber for measuring electrical properties of said fuel indicative of fuel content.

12. The assembly as recited in claim 10, wherein said first opening is disposed along a first axis, and said second opening is disposed along a second axis spaced apart from said first axis.

13. The assembly as recited in claim 12, wherein said fluid chamber is centered around a longitudinal axis transverse to said first axis and said second axis.

14. The assembly as recited in claim 10, including a back plate defining a portion of said fluid chamber.

15. The assembly as recited in claim 14, wherein said sensor comprises a cathode comprising said housing and said back plate and an anode disposed within said fluid chamber.

16. The assembly as recited in claim 10, wherein said first opening comprises a slot.

17. The assembly as recited in claim 10, wherein said housing comprises a metal injection molded article.
